(19) United States
(12) Patent Application Publication
(10) Pub. No.: US 2006/0263656 A1
(43) Pub. Date: Nov. 23, 2006

(54) Power system with reformer

(75) Inventors: Larry L. Johnson, Overland Park, KS (US); Julie A. Willets, Overland Park, KS (US); Jerry D. Meyers, Olathe, KS (US)

Correspondence Address: SPRINT COMMUNICATIONS COMPANY L.P., 6391 SPRINT PARKWAY, KSOPHT0101-Z2100, OVERLAND PARK, KS, 66251-2100, US

(73) Assignee: Sprint Communications Company L.P., Overland Park, KS (US)

(21) Appl. No.: 11/132,013

(22) Filed: May 18, 2005

(51) Int. Cl. H01M 8/06

(52) U.S. Cl. 429/19; 429/34; 429/17

(57) ABSTRACT

The present invention is a power system using a reformer/fuel cell arrangement as the primary source of power. The reformer is operated on either natural gas or propane. A backup source of power comprises a fuel cell which operates on stored hydrogen. The system also includes capacitors which are used to bridge when the system is transferred from the primary source to the backup source.

### CROSS-REFERENCE TO RELATED APPLICATIONS

None.

### STATEMENT REGARDING FEDERALLY SPONSORED RESEARCH OR DEVELOPMENT

None.

### FIELD OF THE INVENTION

In general, this invention relates to the field of providing reliable power. More specifically, the field of providing DC power to telecommunications equipment.

### BACKGROUND OF THE INVENTION

Traditionally, commercial power from a utility has been used as a primary source of electrical power. Telecommunications power systems have included backup power arrangements which attempt to ensure continued power in the event of black-outs and other disturbances in the commercial power grid. To accomplish this, a diesel generator is often used as a backup power source. This diesel generator is backed up by an array of valve-regulated lead-acid (VRLA) batteries.

These conventional systems, however, have their limitations. For one, because they are dependant on commercial electrical power, they cannot be used in remote locations. Much of the globe is currently without telecommunications services simply because they are currently excluded from the commercial power grid.

The use of diesel generators has also proved problematic. This is because they are noisy and emit harmful exhausts, e.g., carbon monoxide. These operational characteristics preclude their use indoors and make it undesirable to locate the diesel generator near occupied areas.

The VRLA batteries incorporated into the conventional systems have also proved to be problematic. First of all, they require considerable space. Additionally, they produce harmful and corrosive gases and, thus, require ventilation. They are difficult to dispose of because of environmental problems. Further, they have a short life and must be replaced every few years. Finally, they are not suitable for extremely hot or cold environments, thus, they must be kept in climate-controlled environments in many remote geographical areas.

### SUMMARY OF THE INVENTION

The present invention comprises a system which overcomes the disadvantages in the prior art systems by using a system for providing electrical power.

The system comprises a gas-extraction device for extracting a first source of gas from a first source of fuel. Also included is a first gas-consuming device for noncombustibly using said first source of gas to create a first source of electrical power. A storage container is provided for a second source of gas. The second source of gas is maintained and is available for noncombustive consumption by one of said first gas-consuming device and a second gas-consuming device for the purpose of providing an alternative source of electrical power.

### BRIEF DESCRIPTION OF THE DRAWINGS

The present invention is described in detail below with reference to the attached drawing figures, wherein:

FIG. 1 is a schematic showing how the components of the present invention are functionally interconnected and thus operate together; and

FIG. 2 is a flow chart showing the energy-management processes of the present invention.

### DETAILED DESCRIPTION OF THE INVENTION

The present invention has numerous advantages over conventional power systems. It is compact, efficient, reliable, and may be operated without connecting the system into the commercial electrical power grid or into a natural gas pipeline utility. This makes the system transportable to remote locations—locations in which telecommunications services (e.g., wireless) are presently unavailable.

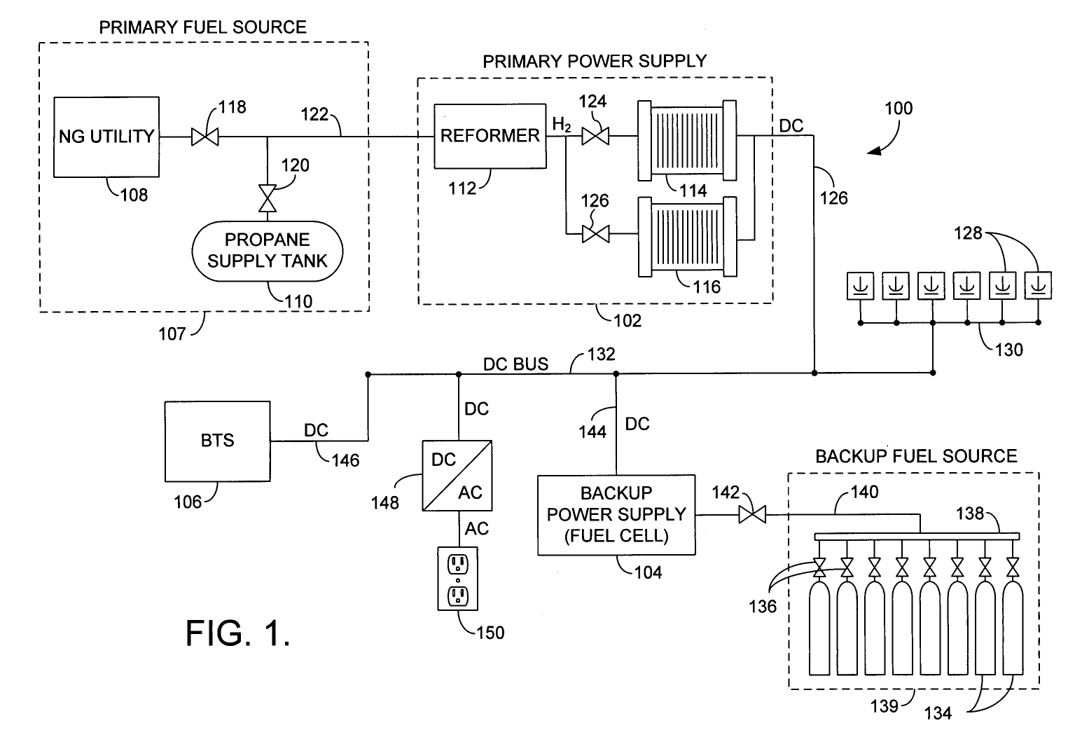

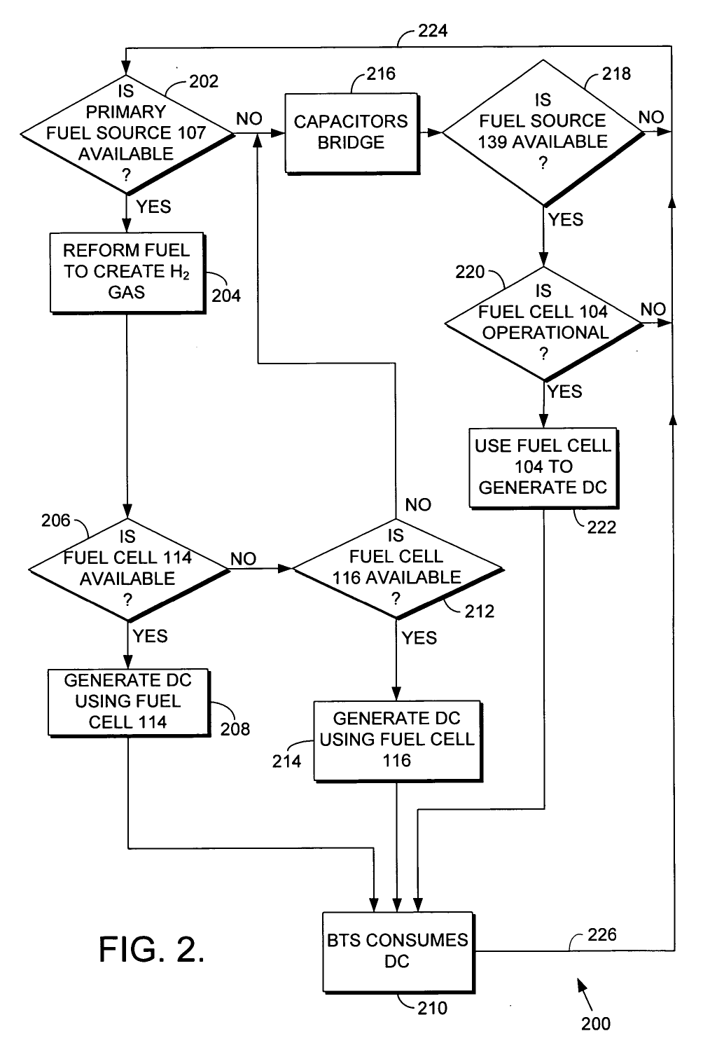

One embodiment of the present invention is disclosed in FIG. 1 and the flow chart of FIG. 2. Looking first to FIG. 1, we see a schematic representation of a power system 100. System 100 includes a primary power supply 102 and a backup power supply 104. These two supplies are used to ensure that DC power is maintained to the power-distribution unit (not shown) for a base transceiver station (BTS) 106. BTS 106 is the radio-hardware portion of a cellular base station. It is involved in the transmission and receiving of voice and data. Power distribution units comprise the electrical equipment for making the necessary connections into the telecommunication cell-site equipment.

It should be understood that it is important that power is not lost to the BTS—even temporarily. Failures could irrevocably damage customer relations. Customers are becoming increasingly dependent on telecommunications systems to handle important matters, e.g., financial transactions.

The system and processes here reduce the possibilities for failure. This is done by maintaining constant DC power in a DC bus 132 into which BTS 106 is electrically connected via a line 146. In normal operation, primary source 102 provides DC power into bus 132. DC power is continually consumed by BTS 106. Reliability is accomplished using the disclosed system and methods which provide backup contingencies to accommodate situations where the primary power supply 102 fails.

Primary power supply 102 operates using a primary fuel source 107.

Primary fuel source 107 comprises two optional fuel sources. The first is natural gas from a utility 108. Use of this source requires availability to natural gas service. This may or may not be possible, but the system is not natural-gas dependent.

If natural gas is not available, the system is able to alternatively use propane or stored high-pressure natural gas. Propane is maintained on site in a propane supply tank 110. Propane may be transported in tanks, but more typical is that tank 110 is located and filled on site by a tanker truck or by other means. Propane may be the only option in locations in which natural gas is not available. For example, in the South-American rainforest natural gas from a utility is not available and in these remote areas, the system would likely only include the propane component 110.

Because the system is completely untied to any physically connected utility, it may be used to offer cell service to locations and people who have never had access to cell service before. Propane is deliverable almost anywhere. Thus, cell towers are freed from geographic bondage caused by the need for utility connectivity.

If natural gas is available, however, both options will exist. Thus, the operator is able to choose between natural gas source 108 or propane source 110 or even bottled high-pressure natural gas depending on cost.

Regardless of whether natural gas or propane is used, fuel from source 107 is consumed by a hydrogen reformer 112. Hydrogen reformers are devices which extract the hydrogen contained in fuels. This extraction is accomplished by catalytic reaction which separates the hydrogen from the carbon in the fuel, then mixes the carbon to form carbon dioxide. The carbon dioxide is then released into the atmosphere. The hydrogen extracted may then be consumed by a fuel cell to produce DC power.

Reformer 112 in FIG. 1 is used to supply one of two fuel cells, a first fuel cell 114 and a spare fuel cell 116. Ordinarily, only first fuel cell 114 is operational. Spare fuel cell 116 is called into action only if fuel cell 114 fails, or needs to be taken off line, e.g., for maintenance. When necessary, switching between fuel cells 114 and 116 is easily accomplished using valves 124 and 126. In ordinary operation, valve 124 will be open and valve 126 will be closed. This causes the hydrogen extracted by reformer 112 to be consumed by fuel cell 114. If fuel cell 114 becomes unavailable, an operator or an automated system will cause valve 124 to close and valve 126 to open. This will cause the hydrogen to be consumed by spare fuel cell 116.

Fuel cells are electrochemical energy-conversion devices. They utilize hydrogen and oxygen. Most fuel cells include proton-exchange membranes (PEMs) or other equivalent devices. PEMs cause the electron from hydrogen to be removed temporarily. Later, this hydrogen electron is returned when the hydrogen is combined with the oxygen to produce water. This creates electricity. The reaction is entirely noncombustive and generates DC electrical power. Because the only by-products of this reaction are heat, water, and electricity, a fuel cell is friendly to the environment. In addition, a fuel cell is capable of providing electrical power for as long as hydrogen fuel is supplied to the unit. It does not discharge over time like a battery.

In the preferred embodiment disclosed in FIG. 1, fuel cells 114 and 116 each include at least one proton-exchange membrane (PEM). Most fuel cells include a plurality of PEMs. Though fuel cells 114 and 116 use PEMs, other fuel-cell technologies exist which might be used and still fall within the scope of the present invention. One example of a PEM-type fuel cell which is suitable for use with the present invention is the modular, cartridge-based, proton-exchange membrane 1-1000 power module manufactured by Reli-On, Inc. of Spokane, Wash.

The DC outputs of both fuel cells 114 and 116 are received into electrical line 126 which is connected into DC bus 132. Only one of the fuel cells, however, will produce DC output at a given time depending on the current status of valves 124 and 126. From bus 132, the DC output from the fuel cell in use (either fuel cell 114 or fuel cell 116) serves as the primary provider of DC power in the system.

If primary power supply 102 fails for some reason, a plurality of capacitors 128 will immediately pick up the load temporarily to bridge. For example, capacitors 128 provide DC power during the time it takes for the control system to (i) switch between fuel sources (e.g., natural gas 108 and propane 110), (ii) switch between power supplies 102 and 104, (iii) deliver natural gas or propane to reformer 112, (iv) cause hydrogen to be produced and then be delivered to one of fuel cells 114 or 116 from reformer 112, or (v) deliver hydrogen from storage tanks 134 to generate DC using fuel cell 104. Thus, it is important that the capacitor arrangement have sufficient discharge time which is able to accommodate the longest of these possible delays. Another function of these capacitors is that they help smooth out the DC output of the primary power supply 102. The electrical output of whatever fuel cell is in use (114 or 116) fluctuates. To make this DC output consistent, the capacitors fill in for any dips in power providing a constant output level. One type of capacitor that is suitable for use in this invention is a supercapacitor manufactured by Maxwell Technologies located in San Diego, Calif.

Though six capacitors are shown in use in FIG. 1, it should be recognized that different numbers and types of capacitors would be used to accommodate specific discharge and load requirements. Satisfying these requirements would fall within the knowledge of one skilled in the art.

The use of capacitors provides advantages over conventional VRLA battery arrangements. Capacitors require less space, are safer in that they do not produce harmful and corrosive gases or present any other significant ecological problems, require no ventilation, almost never need to be replaced and are suitable for extreme hot or cold environments which are typical in remote geographic areas.

It takes system 100 about 14 seconds to switch between primary power supply 102 and the backup supply 104. Capacitors 128 are able to temporarily deliver power during this switch.

Backup supply 104, in the disclosed embodiment, is a fuel cell similar to fuel cells 114 and 116 included in the primary source. In the FIG. 1 arrangement, fuel cell 104 is fueled by a backup fuel source 139. In the disclosed embodiment, backup source 139 comprises a hydrogen storage and delivery system. More specifically, fuel cell 104 receives hydrogen fuel via tubing from a plurality of pressurized hydrogen tanks 134. Eight tanks are shown in the FIG. 1 disclosed embodiment, but the number used is not critical. More or less tanks of varying volumes could be used and still fall within the scope of the present invention.

The rate of hydrogen flow is controlled using automated valves 136. One valve heads each of the tanks 134. Each of these valves 136 enables its tank to be individually sealed off, e.g., when a tank needs to be changed out. Valves 136 also enable the stored hydrogen to be released when needed.

Above each of the valves 136 for tanks 134 is a common manifold 138. Manifold 138 enables equal pressures to be maintained in each of the plurality of tanks 134 when valves 136 are opened. Downstream from manifold 138, tubing 140 includes a valve 142. If valve 142 and valves 136 are opened, the pressurized hydrogen is released from the tanks and is consumed by fuel cell 104. When this happens, a DC power output 144 is produced and is introduced into DC bus 132. This arrangement makes the fuel-cell-produced DC power available to BTS 106.

Though not shown, the power system of the present invention also comprises a control system which includes a number of sensing and control mechanisms (not shown) for determining which fuel source to activate and which power source to engage. As will be known to one skilled in the art, these kinds of automated systems may be separate devices or may be integral to the valves, bus lines, and/or devices being monitored. Likewise, the control mechanisms may be separate devices, such as programmable logic controllers, or may be integrated into the components already described.

Regardless, these techniques of monitoring and activating equipment will be known to one skilled in the art, and one skilled in the art will know how to arrange these devices such that (i) valves 118 and 120 are opened or closed to select between natural gas and propane, (ii) failure of the primary power supply 102 is detected because of the lack of fuel or some mechanical problem, (iii) a failure in fuel cell 114 is detected prompting a switch to fuel cell 116 by closing valve 124 and opening valve 126, (iv) backup power supply/fuel cell 104 will be activated when needed, (v) valve 142 and automated valves 136 are opened to supply fuel cell 104, and (iv) other automated requirements are met. Particular arrangements for accomplishing these objectives will be evident to and fall within the abilities of one skilled in the art.

The system also provides a low-voltage AC outlet 150 with an inverter for the purpose of providing the user with AC power, e.g., 120V. To accomplish this, an inverter 148 receives DC power from bus 132 and converts it to useable AC power. Outlet 150 might be used, e.g., for operating power tools or other small electronic devices. Again, the overall system 100 can be located in places not on the AC power grid and when in these locations, outlet 150 enables a user to access 120V AC, because AC from a utility will not otherwise be available.

A power-management flow chart 200 of FIG. 2 shows both the operational aspects of system 100 as well as different contingency plans in terms of energy management in the face of a variety of events. In a first step 202 of the process, an inquiry is made as to whether primary fuel source 107 is available. This step will depend on how the system is initially set up. In situations in which both natural gas and propane are possible fuel sources (e.g., the site is located where utility natural gas is available), the user will typically make a cost assessment as to which fuel is currently desirable. If natural gas is less expensive, and available, that source will be used first. Whether natural gas is available to the system from the utility is detected by a pressure sensor located upstream of valve 118. This pressure sensor will detect whether sufficient pressure exists in the line to drive reformer 112.

If the natural gas then becomes unavailable, the propane (or stored high-pressure natural gas) is used as a fall-back option. With respect to propane, tank 110 will typically comprise a microprocessor-controlled fuel pressure valve and indicator which cooperates with the control system to automatically determine fuel availability.

If system 100 is incorporated into an area where utility natural gas is not available, e.g., in remote locations, propane alone will be the only potential fuel. In this situation, step 202 will ask only whether sufficient propane exists in tank 110 to operate reformer 112.

Regardless, if any fuel in primary fuel source 107 is available (natural gas or propane) the answer to inquiry 202 will be yes, and the process will move on to a step 204.

In step 204, reformer 112 will receive fuel from whatever fuel source is available (108 or 110) and begin the hydrogen-extraction process. If natural gas 108 is the available fuel, valve 118 will open up and natural gas will travel down tube 122 into the reformer intake. If propane is the available fuel, valve 120 will open up and tube 122 will transmit propane to reformer 112. Once reformer 112 receives either fuel, it will begin producing hydrogen gas.

Where the hydrogen is consumed will depend on the answer to an inquiry step 206. Step 206 asks whether fuel cell 114 is available. If fuel cell 114 is functional, and has not been taken out of service for some reason, valve 124 will be open (valve 126 will remain closed) and fuel cell 114 will begin to noncombustibly consume the hydrogen extracted by reformer 112. This creates a DC output in line 126 in a step 208. This DC output is then introduced into bus 132 for consumption by BTS 106 in step 210. This is the normal mode of operation.

If, however, fuel cell 114 is not available for some reason, e.g., fuel cell 114 is being serviced, the process will then move on to a step 212. Step 212 inquires as to whether spare fuel cell 116 is available. If so, valve 124 will be closed and valve 126 opened. This will cause the hydrogen produced by the reformer to be diverted to fuel cell 116, which will begin to noncombustibly consume hydrogen to produce DC power in a step 214. The DC output created by fuel cell 116 is then received into line 126. From there it is introduced into bus 132 for consumption by BTS 106 in step 210.

If, in step 212, spare fuel cell 116 is unavailable like fuel cell 114, or if in step 202 a determination is made that no primary fuel source 107 is available, the process will arrive at a step 216 in which the capacitors 128 will temporarily bridge. This means they will drain (for a limited time) to provide the necessary DC to the BTS in step 210.

Next, an inquiry will be made in a step 218 as to whether backup fuel source 139 is available. This determination will be made by the automated control system which determines whether sufficient pressure exists in tanks 134 to drive the backup fuel cell 104. If not, the process moves in a loop 224 back to initial step 202. This continuous looping ensures detection when the primary supply system 102 has returned to service. If the primary systems have not returned to service, capacitors 128 will continue to bridge in step 216.

If, in step 218, sufficient hydrogen pressure is detected in tanks 134, valve 142 will open up and hydrogen will advance to fuel cell 104. The process will then reach a step 220 in which an inquiry is made as to whether fuel cell 104 is yet operational. It will take some time, typically about 14 seconds, from when valve 142 is opened up and when fuel cell 104 has begun to receive and consume fuel. Until the fuel cell is operational, inquiry step 220 will direct the process back through loop 224 and the capacitors will continue to bridge (unless the primary power supply 102 has been restored). If fuel cell 104 has become operational, however, the process will proceed to a step 222 and fuel cell 104 will consume the stored hydrogen and generate DC which will be consumed by the BTS.

Once operational, fuel cell 104 will continue to generate DC output in step 222 until (i) the hydrogen runs out or (ii) the primary power supply 102 comes back on line. Even though the backup system is operational in step 222, the process continuously checks (via a loop 226) to see if the primary power supply 102 has been restored. If so, the backup power supply 104 will shut down, and the reformer system 102 will be returned to service.

Through these processes, system 100 is able to provide efficient, reliable power in remote locations without significantly affecting the surrounding environs.

It will be appreciated by persons skilled in the art that the present invention is not limited to what has been particularly shown and described hereinabove. Rather, all matter shown in the accompanying drawings or described hereinabove is to be interpreted as illustrative and not limiting. Accordingly, the scope of the present invention is defined by the appended claims rather than the foregoing description.

What is claimed is:

1. A system for providing electrical power, said system comprising:
a gas-extraction device for extracting a first source of gas from a first source of fuel;
a first gas-consuming device for noncombustibly using said first source of gas to create a first source of electrical power; and
a storage container for a second source of gas, said second source of gas maintained to be available for noncombustive consumption by one of said first gas-consuming device and a second gas-consuming device for the purpose of providing an alternative source of electrical power.

2. The system of claim 1 wherein said first gas-consuming device is a fuel cell.

3. The system of claim 1 wherein said one of said first gas-consuming device and said second gas-consuming device is a fuel cell.

4. The system of claim 1 wherein said first source of gas is hydrogen.

5. The system of claim 1 wherein said second source of gas is hydrogen.

6. The system of claim 1 wherein said storage container is a hydrogen tank.

7. The system of claim 1 wherein said gas-extraction device is a reformer.

8. The system of claim 1 comprising:
a substitute gas-consuming device which may be automatically substituted for said first gas-consuming device wherein said first gas-consuming device becomes unavailable.

9. The system of claim 1 comprising:
at least one capacitor for maintaining constant power.

10. The system of claim 9 comprising:
at least one capacitor for maintaining constant power.

11. The system of claim 1 comprising:
a circuit for receiving both said first and second electrical sources of power; and
a power-consuming device included in said circuit.

12. The system of claim 11 comprising:
at least one capacitor in said circuit for maintaining constant power regardless of the availability of said first and second sources of said power.

13. The system of claim 11 comprising:
an electrical outlet in said circuit which enables the user to access AC power.

14. The system of claim 13 comprising:
an inverter electrically interposed between said circuit and said outlet.

15. The system of claim 1 wherein said first source of fuel is one of a propane tank and a natural gas utility.

16. The system of claim 15 wherein said source of fuel is a propane tank and said system is operable independently without contribution from a utility company.

17. A method of providing electrical power to a power-consuming device, comprising:
incorporating said power-consuming device into a circuit;
incorporating an output of a first fuel cell into said circuit;
extracting hydrogen from a fuel to supply said first fuel cell if needed for providing electrical power to said power-consuming device;
incorporating an output of a second fuel cell into said circuit;
receiving hydrogen from a storage container to supply one of said first fuel cell and a second fuel cell if needed for providing electrical power to said power-consuming device.

18. The method of claim 17, comprising:
including at least one capacitor in said circuit; and
eliminating power drops in said circuit using said at least one capacitor.

19. The method of claim 17, comprising:
executing said receiving step when said extracting step is unperformable.

20. A power system comprising:
a circuit;
a hydrogen extractor operable on one of natural gas and propane;
a first fuel cell for receiving hydrogen from said hydrogen extractor, said first fuel cell having a first DC output included in said circuit;
a hydrogen storage container;
a second fuel cell operable using hydrogen received from said storage container; said second fuel cell having a second DC output included in said circuit; and
at least one capacitor in said circuit to prevent power drops in said circuit.
